(19) United States
(12) Patent Application Publication
(10) Pub. No.: US 2023/0049946 A1
(43) Pub. Date: Feb. 16, 2023

(54) Communications Method and Communications System for Determining a Transmission Scheme According to at Least One Temporal Parameter

(71) Applicant: MediaTek Singapore Pte. Ltd., Singapore (SG)

(72) Inventor: Gyu Bum Kyung, San Jose, CA (US)

(73) Assignee: MediaTek Singapore Pte. Ltd., Singapore (SG)

(21) Appl. No.: 17/794,616

(22) PCT Filed: Feb. 3, 2021
(86) PCT No.: PCT/SG2021/050057

§ 371 Date: Jul. 22, 2022

Related U.S. Application Data
(60) Provisional application No. 62/969,702, filed on Feb. 4, 2020.

(51) Int. Cl. H04W 72/12; H04W 76/10

(52) U.S. Cl. CPC H04W 72/1263; H04W 76/10; H04W 72/1289

(57) ABSTRACT

A communications method for determining a transmission scheme according to at least one temporal parameter includes providing a communication device, a first transceiver, and a second transceiver, acquiring the at least one temporal parameter, establishing a first link between the communication device and the first transceiver during a first time slot according to the at least one temporal parameter, and establishing a second link between the communication device and the second transceiver during a second time slot according to the at least one temporal parameter. The first time slot and the second time slot are non-overlapped.

### BACKGROUND OF THE INVENTION

### 1. Field of the Invention

The present invention illustrates a communications method and a communications system for determining a transmission scheme, and more particularly, a communications system for determining a transmission scheme according to at least one temporal parameter.

### 2. Description of the Prior Art

With the rapid advancements of technologies, several 5th generation (5G) communications are developed and become trends of future telecom or mobile technologies. For example, Ultra-reliable low-latency communications (URLLC) belong to one of several different types of usage cases supported by a 5G new radio (NR) standard. Some physical layer enhancement methods are also introduced to the URLLC according to the 5G NR standard. Generally, the URLLC having the 5G NR standard can be applied to several entertainment communications and industry communications, such as augmented reality (AR) communications, virtual reality (VR) communications, factory automation communications, transport industry communications, and electrical power distribution communications. Targets of the physical layer enhancement methods for the URLLC having the 5G NR standard are to provide a high reliability (e.g., an error rate around 10⁻⁶) and a short latency (e.g., 0.5-1 milliseconds).

In NR with multiple transmission and reception points (TRPs), user equipment (UE) can communicate to more than one TRP physically separated in different locations at the same time. However, when the UE transmit a signal to two TRPs simultaneously, channel conditions could vary fast, leading to performance degradation with the same transmission scheme. Specifically, for millimeter wave (mm-Wave) system, the transmitted and received signals are processed with beamforming technologies for enhancing communication performance. However, for the mm-Wave system, the signals may suffer abrupt time characteristic change or even link quality degradation due to blockage issues. These blockage issues also depend on the locations of TRPs and UE. Therefore, to develop an adaptive transmission scheme over time for the multiple TRPs system is an important design issue.

### SUMMARY OF THE INVENTION

In an embodiment of the present invention, a communications method for determining a transmission scheme according to at least one temporal parameter is disclosed. The communications method comprises providing a communication device, a first transceiver, and a second transceiver, acquiring the at least one temporal parameter, establishing a first link between the communication device and the first transceiver during a first time slot according to the at least one temporal parameter, and establishing a second link between the communication device and the second transceiver during a second time slot according to the at least one temporal parameter. The first time slot and the second time slot are non-overlapped.

In another embodiment of the present invention, a communications system for determining a transmission scheme according to at least one temporal parameter is disclosed. The communications system comprises a communication device, a first transceiver, and a second transceiver. The first transceiver is configured to communicate with the communication device. The second transceiver is configured to communicate with the communication device. After the at least one temporal parameter is acquired, a first link between the communication device and the first transceiver is established during a first time slot according to the at least one temporal parameter. A second link between the communication device and the second transceiver is established during a second time slot according to the at least one temporal parameter. The first time slot and the second time slot are non-overlapped.

### BRIEF DESCRIPTION OF THE DRAWINGS

FIG. 1 is an illustration of a communications system for determining a transmission Scheme during a first time slot according to an embodiment of the present invention.

FIG. 2 is an illustration of determining a transmission Scheme during a second time slot of the communications system in FIG. 1.

FIG. 3 an illustration of a pre-determined sequence used for determining a transmission Scheme of the communications system in FIG. 1.

FIG. 4 is a flow chart of a communications method for determining a transmission scheme performed by the communications system in FIG. 1.

### DETAILED DESCRIPTION

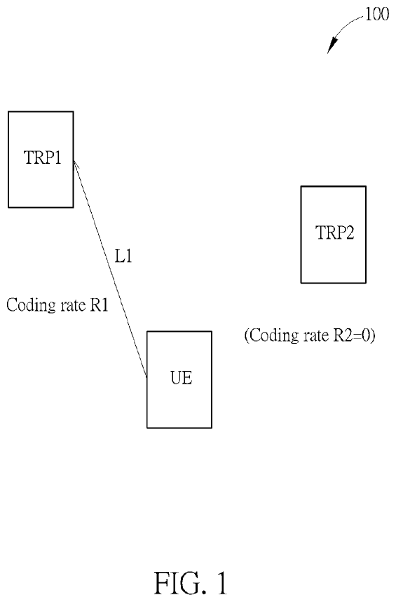

FIG. 1 is an illustration of a communications system 100 for determining a transmission scheme during a first time slot according to an embodiment of the present invention. The communications system 100 includes a communication device UE, a first transceiver TRP1, and a second transceiver TRP2. The communication device UE can be any portable, mobile, or fixed communication device capable of transmitting and receiving wireless signals. The first transceiver TRP1 and the second transceiver TRP2 can be two communication terminals capable of performing an uplink data transmission process and a downlink data transmission process with the communication device UE. The first transceiver TRP1 can be used for communicating with the communication device UE under a TDD (Time Division Duplexing) mode or an FDD (Frequency Division Duplexing) mode. The second transceiver TRP2 is used for communicating with the communication device UE under the TDD or the FDD mode. In the communications system 100, after the at least one temporal parameter is acquired, a first link L1 between the communication device UE and the first transceiver TRP1 can be established during a first time slot according to the at least one temporal parameter. Then, a second link L2 between the communication device UE and the second transceiver TRP2 can be established during a second time slot according to the at least one temporal parameter. The first time slot and the second time slot are non-overlapped.

For example, in FIG. 1, during the first time slot, the first link L1 between the communication device UE and the first transceiver TRP1 is established. The second link L2 between the communication device UE and the first transceiver TRP1 is blocked after the first link L1 between the communication device UE and the second transceiver TRP2 is established. Then, the communication device can transmit data to the first transceiver TRP1 under a first coding rate R1 through the first link L1 during the first time slot. Since the second link L2 between the communication device UE and the second transceiver TRP2 is blocked, a second coding rate R2 can be regarded as zero throughput (R2=0).

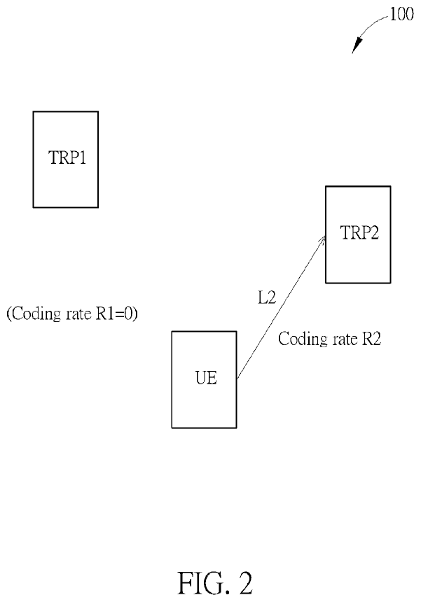

FIG. 2 is an illustration of determining a transmission scheme during a second time slot of the communications system 100. Similarly, during the second time slot, the second link L2 between the communication device UE and the second transceiver TRP2 is established. Then, the communication device can transmit data to the second transceiver TRP2 under a second coding rate R2 through the second link L2 during the second time slot. Since the first link L1 between the communication device UE and the first transceiver TRP1 is blocked, a first coding rate R1 can be regarded as zero throughput. In FIG. 1 and FIG. 2, the first coding rate R1 and the second coding rate R2 are different. In the communications system 100, the communication device UE can use different coding rates (R1 and R2) for transmitting the same data to the first transceiver TRP1 and the second transceiver TRP2 during different time slots for enhancing signal reliability. Further, in the communications system 100, several transmission schemes can be introduced according to at least one temporal parameter. The at least one temporal parameter is relevant to a mapping correlation defined by a table. The at least one temporal parameter can be dynamically changed by channel conditions or signal strength, as illustrated below.

In a first mode, the transmission schemes can be determined according to transmission configuration indicator information (TCI). For example, the at least one temporal parameter can include TCI measured by the communication device UE. The TCI can be regarded as a measurement indicator including various environmental parameters such as channel responses, channel state information, and signal-to-noise ratio. When the first link L1 is established according to the TCI during the first time slot, a channel capacity of the first link L1 is higher than a channel capacity of the second link L2. Conversely, when the second link L2 is established according to the TCI during the second time slot, a channel capacity of the second link L2 is higher than a channel capacity of the first link L1. Therefore, the communication reliability of the communications system 100 can be improved since the communications system 100 can adaptively select a satisfactory link for performing high reliable data transmission.

In a second mode, the at least one temporal parameter can include downlink control information (DCI) from a physical downlink control channel (PDCCH) received by the user equipment UE. The communication device UE can dynamically switch a link between the first link L1 and the second link L2 through the DCI. Therefore, the transmission scheme can be dynamically switched and can be informed to the first transceiver TRP1 or the second transceiver TRP2 through DCI. For a single DCI case (i.e., if one DCI resource is sent from the first transceiver TRP1 and the second transceiver TRP2), the at least one temporal parameter includes orders of redundant version (RV) sequence of downlink control information (DCI) from a physical downlink control channel (PDCCH). For example, the orders of RV sequence can be orders of incremental redundancy data segments of turbo code applied to the error correcting code words. Further, the communication device UE can indicate number of repetitions and resource allocations according to the RV sequence for switching an appropriate link between the first link L1 and the second link L2. Moreover, an RV identity in the DCI represents two different or same RVs as one pair. A first element of the pair can be applied for a first TCI state. A second element of the pair can be applied for a second TCI state. Therefore, since the first link L1 and the second link L2 are conditionally established, signal reliability of the communications system 100 can be improved.

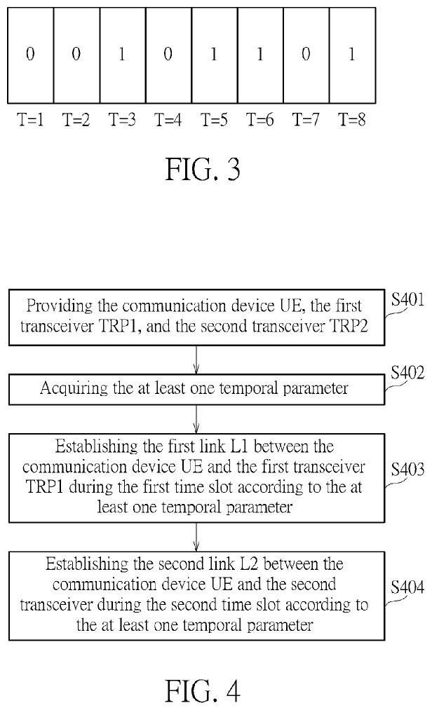

FIG. 3 an illustration of a pre-determined sequence used for determining the transmission Scheme of the communications system 100. In a third mode, a “semi-static” switching-based transmission scheme can be introduced to the communications system 100. The at least one temporal parameter includes a pre-determined sequence. The pre-determined sequence includes allocation information of link establishments over time. For example, in FIG. 3, the pre-determined sequence indicates allocation information of link establishments during eight time slots. During a first time slot (T=1), the first link L1 between the communication device UE and the first transceiver TRP1 is established, indicated as a pointer “0”. During a second time slot (T=2), the first link L1 between the communication device UE and the first transceiver TRP1 is established, indicated as a pointer “0”. During a third time slot (T=3), the second link L2 between the communication device UE and the second transceiver TRP2 is established, indicated as a pointer “1”. During a fourth time slot (T=4), the first link L1 between the communication device UE and the first transceiver TRP1 is established, indicated as a pointer “0”. During a fifth time slot (T=5), the second link L2 between the communication device UE and the second transceiver TRP2 is established, indicated as a pointer “1”. During a sixth time slot (T=6), the second link L2 between the communication device UE and the second transceiver TRP2 is established, indicated as a pointer “1”. During a seventh time slot (T=7), the first link L1 between the communication device UE and the first transceiver TRP1 is established, indicated as a pointer “0”. During an eighth time slot (T=8), the second link L2 between the communication device UE and the second transceiver TRP2 is established, indicated as a pointer “1”. The pre-determined sequence can be regarded as a correlation mapping table saved in the communication device UE.

FIG. 4 is a flow chart of a communications method for determining a transmission scheme performed by the communications system 100. The communications method can include step S401 to step S404. Any reasonable technology modification falls into the scope of the present invention. Step S401 to step S404 are illustrated below.
step S401: providing the communication device UE, the first transceiver TRP1, and the second transceiver TRP2;
step S402: acquiring the at least one temporal parameter;
step S403: establishing the first link L1 between the communication device UE and the first transceiver TRP1 during the first time slot according to the at least one temporal parameter;
step S404: establishing the second link L2 between the communication device UE and the second transceiver during the second time slot according to the at least one temporal parameter.

Details of step S401 to step S404 are illustrated previously. Thus, they are omitted here. In the communications system 100, instead of simultaneously communicating two transceivers (TRP1 and TRP2) with the communication device UE, an appropriate link between the communication device with one of the two transceivers (TRP1 and TRP2) is selected for transmitting data. Therefore, when the channel conditions vary fast, transmission performance degradation with the same communication scheme can be avoided.

To sum up, the present invention discloses a communications method and a communications system for determining a transmission scheme according to at least one temporal parameter. The communications system can acquire at least one temporal parameter from TCI states, DCI states, RV orders, and/or pre-defined sequence. Instead of simultaneously communicating two transceivers with the communication device, the communications system can dynamically select only one appropriate link between one transceiver with the communication device for avoiding channel condition degradation. Therefore, when the channel conditions vary fast, transmission performance can be maintained.

What is claimed is:

1. A communications method for determining a transmission scheme according to at least one temporal parameter comprising:
providing a communication device, a first transceiver, and a second transceiver;
acquiring the at least one temporal parameter;
establishing a first link between the communication device and the first transceiver during a first time slot according to the at least one temporal parameter; and
establishing a second link between the communication device and the second transceiver during a second time slot according to the at least one temporal parameter;
wherein the first time slot and the second time slot are non-overlapped.

2. The method of claim 1, further comprising:
blocking the first link between the communication device and the first transceiver after the second link between the communication device and the second transceiver is established.

3. The method of claim 1, wherein the at least one temporal parameter comprises transmission configuration indicator information (TCI) measured by the communication device.

4. The method of claim 3, wherein when the first link is established according to the TCI during the first time slot, a channel capacity of the first link is higher than a channel capacity of the second link, and when the second link is established according to the TCI during the second time slot, a channel capacity of the second link is higher than a channel capacity of the first link.

5. The method of claim 1, wherein the at least one temporal parameter comprises a pre-determined sequence, and the pre-determined sequence comprises allocation information of link establishments over time.

6. The method of claim 1, wherein the at least one temporal parameter comprises downlink control information (DCI) from a physical downlink control channel (PDCCH), and the communication device dynamically switches a link between the first link and the second link through the DCI.

7. The method of claim 1, wherein the at least one temporal parameter comprises orders of redundant version (RV) sequence of downlink control information (DCI) from a physical downlink control channel (PDCCH) if only one DCI is sent from the first transceiver and the second transceiver.

8. The method of claim 7, further comprising:
indicating number of repetitions and resource allocations according to the RV sequence for switching a link between the first link and the second link by the communication device.

9. The method of claim 7, wherein an RV identity in the DCI represents two different or same RVs as one pair, a first element of the pair is applied for a first transmission configuration indicator information (TCI) state, and a second element of the pair is applied for a second TCI state.

10. The method of claim 1, further comprising:
transmitting data from the communication device to the first transceiver under a first coding rate through the first link during the first time slot; and
transmitting the data from the communication device to the second transceiver under a second coding rate through the second link during the second time slot;
wherein the first coding rate and the second coding rate are different, and the at least one temporal parameter is relevant to a mapping correlation defined by a table.

11. A communications system for determining a transmission scheme according to at least one temporal parameter comprising:
a communication device;
a first transceiver configured to communicate with the communication device; and
a second transceiver configured to communicate with the communication device;
wherein after the at least one temporal parameter is acquired, a first link between the communication device and the first transceiver is established during a first time slot according to the at least one temporal parameter, a second link between the communication device and the second transceiver is established during a second time slot according to the at least one temporal parameter, and the first time slot and the second time slot are non-overlapped.

12. The system of claim 11, wherein the first link between the communication device and the first transceiver is blocked after the second link between the communication device and the second transceiver is established.

13. The system of claim 11, wherein the at least one temporal parameter comprises transmission configuration indicator information (TCI) measured by the communication device.

14. The system of claim 13, wherein when the first link is established according to the TCI during the first time slot, a channel capacity of the first link is higher than a channel capacity of the second link, and when the second link is established according to the TCI during the second time slot, a channel capacity of the second link is higher than a channel capacity of the first link.

15. The system of claim 11, wherein the at least one temporal parameter comprises a pre-determined sequence, and the pre-determined sequence comprises allocation information of link establishments over time.

16. The system of claim 11, wherein the at least one temporal parameter comprises downlink control information (DCI) from a physical downlink control channel (PDCCH), and the communication device dynamically switches a link between the first link and the second link through the DCI.

17. The system of claim 11, wherein the at least one temporal parameter comprises orders of redundant version (RV) sequence of downlink control information (DCI) from a physical downlink control channel (PDCCH) if only one DCI is sent from the first transceiver and the second transceiver.

18. The system of claim 17, wherein the communication device indicates number of repetitions and resource allocations according to the RV sequence for switching a link between the first link and the second link by the communication device.

19. The system of claim 17, wherein an RV identity in the DCI represents two different or same RVs as one pair, a first element of the pair is applied for a first transmission configuration indicator information (TCI) state, and a second element of the pair is applied for a second TCI state.

20. The system of claim 11, wherein the communication device transmits data to the first transceiver under a first coding rate through the first link during the first time slot, the communication device transmits the data to the second transceiver under a second coding rate through the second link during the second time slot, the first coding rate and the second coding rate are different, and the at least one temporal parameter is relevant to a mapping correlation defined by a table.
